(19) United States
(12) Patent Application Publication
(10) Pub. No.: US 2026/0124566 A1
(43) Pub. Date: May 7, 2026

(54) PULSE FILTER

(71) Applicant: Neenah Gessner GmbH, Bruckmühl (DE)

(72) Inventors: Armin NIEDERHUBER, Bruckmühl (DE); Anja KAMPE, Bruckmühl (DE)

(21) Appl. No.: 19/380,177

(22) Filed: Nov. 5, 2025

(30) Foreign Application Priority Data
Nov. 7, 2024 (EP) 24211515.2

(51) Int. Cl. B01D 39/18; B01D 39/16; B01D 39/20; B01D 46/62; B01D 46/71

(52) U.S. Cl. CPC B01D 39/18; B01D 39/1623; B01D 39/2003; B01D 46/62; B01D 46/71; B01D 2239/0618; B01D 2239/0622; B01D 2239/0636; B01D 2239/064; B01D 2239/065; B01D 2239/1216; B01D 2239/1258; B01D 2239/1275; B01D 2239/1291

(57) ABSTRACT

Filter media, filter arrangements and filters, such as air filters and pulse filters, are provided. A filter medium comprises a base web of cellulose fibers. The base web comprises a first and a second layer of cellulose fibers and a transition region between the first and the second layers. The cellulose fibers of the first layer and the cellulose fibers of the second layer are intertwined in the transition region. The the base web has a specific volume of from 4 m³/g to 9 m³/g. The first layer may comprise more cellulose fibers, expressed as mass of cellulose fibers per unit area, than the second layer.

### CROSS-REFERENCE TO RELATED APPLICATIONS

This application claims the benefit of European Patent Application No. EP24211515.2, filed Nov. 7, 2024, the complete disclosure of which is incorporated herein by reference for all purposes.

### BACKGROUND

This description generally pertains to the field of filtration. More specifically, it relates to cleanable filter media for air filters, pulse filters and the like.

There is an increasing demand for filter materials that are environmentally friendly and biodegradable, while simultaneously maintaining high filtration performance and efficiency. Prior art discloses filter materials based on cellulose fibers, such as the air and gas filter described in US 2012/167771 A1, as well as water-disintegrable cellulose acetate fiber tow filters disclosed in JP-H09103280 A. CN 102691234 A describes a multi-layer paper filter material, primarily intended for cigarettes, with an emphasis on environmental protection. However, the filter materials disclosed in US 2012/167771 A1, JP-H09103280 A, and CN 102691234 A are single-use and are not intended to be cleanable or reusable.

Methods for producing multilayer paper-based filter materials have been disclosed, including US 2010/000693 A1, which describes the formation of multilayer paper using cellulose fibers, and EP 3540119 A1, which teaches production of multilayer-ply webs with variable pulp compositions using specialized fiber web machinery. Multi-phase filter media based on hardwood and softwood fibers are disclosed in US 2010/116138 A1, which employs rotoformers in the examples. Similarly, U.S. Pat. No. 6,464,830 B1 describes the formation of multilayer paper webs using hard and softwood fibers. However, none of these references address the need for cleanable filter materials capable of repeated use.

Some filter materials are designed as cleanable or reusable filters due to their structural characteristics. For example, in surface filtration, the first filtration layer in the flow direction comprises smaller pores, while subsequent layers contain progressively larger pores. This arrangement ensures that the majority of particles, regardless of size, are captured at the outermost layer, forming a filter cake. The filter cake can be removed through cleaning steps such as tapping, shaking, washing, pressure shock, or backwashing, allowing the filter to be reused for multiple cycles, also known as pulse cycles. The lifetime of a cleanable filter is determined by the number of cycles it can endure without excessive pressure drop or incomplete particle removal, which are critical performance characteristics in practical applications.

WO 2013/029697 A2 discloses a multilayer cleanable filter material, including surface filter elements for separating solid impurities in gases and liquids. To improve fine particle separation, the filter material includes an upstream melt-blown layer formed from thermoplastic material. While effective, the use of multiple layers of different materials, including melt-blown thermoplastics, presents environmental concerns and leaves room for improvement in terms of sustainability and end-of-life degradation.

Accordingly, there remains a need for a cleanable filter medium that is environmentally friendly, provides excellent general filtering properties such as air permeability and dust capture, and maintains a long operational lifetime during repeated cleaning or pulse cycles.

### SUMMARY

This following is intended merely to introduce a simplified summary of some aspects of one or more embodiments of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

Filter media, filter arrangements and filters, such as air filters and pulse filters, are provided.

In one aspect, a filter medium comprises a base web of cellulose fibers. The base web comprises a first and a second layer of cellulose fibers and a transition region between the first and the second layers. The cellulose fibers of the first layer and the cellulose fibers of the second layer are intertwined in the transition region. The base web has a specific volume of from 4 m³/g to 9 m³/g.

In embodiments, the first layer may comprise more cellulose fibers, expressed as mass of cellulose fibers per unit area, than the second layer.

In embodiments, the base web of cellulose fibers is a two-layered base web consisting of the first and the second layer of cellulose fibers with the transition region between them.

In embodiments, the base web comprises an air permeability from about 400 to about 800 l/m²s.

In embodiments, the base web has a thickness thereof from about 150 μm to about 300 μm.

In embodiments, the base web has a basis weight from about 25 to about 55 g/m².

In embodiments, the base web has a tensile strength ratio MD/CD thereof is from about 2 to about 3.2.

In embodiments, the base web has a maximum pore size from about 90 μm to about 130 μm.

In embodiments, the second layer contains curled fibers, in an amount of 15 wt.-% to 40 wt.-%, in terms of the weight of the cellulose fibers of the second layer.

In embodiments, the second layer comprises uncurled fibers, in an amount of 60 to 85 wt.-%, in terms of weight of the cellulose fibers of the second layer.

In embodiments, the base web contains about 15 to 40 wt.-%, or about 25 to 35 wt.-%, of curled fibers, in terms of the weight of the cellulose fibers of the base web in total.

In embodiments, the base web wherein the cellulose fibers of the second layer are softwood fibers.

In embodiments, the base web is a non-impregnated base web of cellulose fibers.

In another aspect, a filter arrangement comprises a first filter comprising a base web of cellulose fibers, wherein the base web comprises a first and a second layer of cellulose fibers and a transition region between the first and the second layers, wherein the cellulose fibers of the first layer and the cellulose fibers of the second layer are intertwined in the transition region, wherein the base web has a specific volume from 4 m³/g to 9 m³/g, and a second filter.

In embodiments, the second filter comprises a glass filter.

In embodiments, the second filter comprises a paper filter.

In embodiments, the second filter comprises a meltblown filter.

In embodiments, the filter arrangement further comprises at least one nonwoven filter layer arranged upstream of the first filter or downstream of the second filter.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE FIGURES

FIG. 1 is a scanning electron microscopy (SEM) image showing the cross-section of the base web produced in Example 1. The following layers are arranged from bottom to top, the first layer is at the bottom of the base web, followed by the transition region, followed by the second layer.

FIG. 2 shows the efficiency of the filter material of Example 1 in relation to the particle size of the dust according to ISO 5011 measurements.

FIG. 3 shows a graph depicting the deterioration of a pulse filter comprising the base web produced in Example 1 over a certain number of pulse cycles. A standardized dust concentration of 5000 mg/m³, a test flow rate of 5 m³/h and a cycle frequency of 2000 pulse cycles à 5 s are used. The graph illustrates the measurement of the filter medium.

FIG. 4 shows a graph depicting the deterioration of a pulse filter comprising the material of Comparative Example 1 (a pulse filter material common in the art) over a certain number of pulse cycles. A standardized dust concentration of 5000 mg/m³, a test flow rate of 5 m³/h and a cycle frequency of 2000 pulse cycles à 5 s are used. The graph illustrates the measurement of the filter medium.

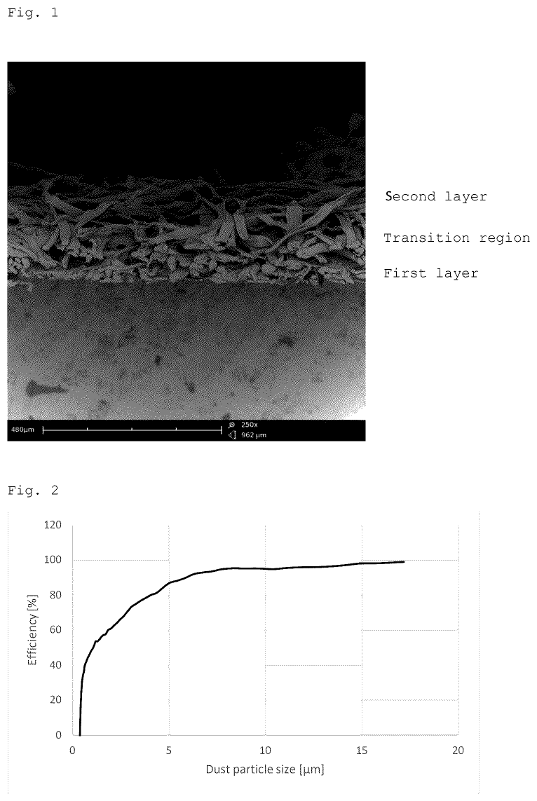

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

All references cited herein are hereby incorporated by reference in their entireties. In the event of a conflict in a definition with a cited reference, the present teachings control.

As used herein, the terms “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per=the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within 5 thin two-fold, of a value. Wt % herein, unless otherwise specified is w/w %.

The following definitions are provided in the context of the present disclosure:

The term “base web” as used herein refers to a fibrous sheet made of a single ply, as there is a continuous transition from the first layer to the second layer where the fibers of the first and second layer are intertwined in a transition region and as such, the single ply cannot be divided into two layers.

The term “fiber” as used herein refers to a material form characterized by an extremely high ratio of length to diameter. Fibers used herein are preferably cellulose fibers.

The term “cellulose fiber” as used herein refers to cellulose fibers, which for instance are obtainable from wood, bark or leaves of plants. Cellulose fibers originating from wood may be hardwood pulp, bleached hardwood pulp, softwood pulp, bleached softwood pulp, softwood fluff pulp, lyocell fibers (cellulose fibers which are ground and dissolved in N-methylmorpholine N-oxide monohydrate for the purpose of obtaining fibers with a cross section of variable shape (round, oval, cross-shaped, circular, lamellar cross section) with calibrated length and mass per unit length, which the person skilled in the art can choose depending on their needs), viscose fibers (fibers obtained by dissolving cellulose by means of modification of its hydroxyl groups by carbon disulfide (CS₂) and then precipitating it in the presence of sulfuric acid (H₂SO₄) for the purpose of obtaining fibers with a cross section of variable shape (round, oval, cross-shaped, circular, lamellar cross section) with calibrated length and mass per unit length, which the person skilled in the art can choose depending on their needs) or mixtures thereof, preferably bleached softwood pulp, softwood pulp, softwood fluff pulp, lyocell fibers, viscose fibers or mixtures thereof, more preferably bleached softwood pulp, softwood pulp, softwood fluff pulp or mixtures thereof, still more preferably northern softwood kraft (NBSK) pulp.

The term “specific volume” as used herein refers to the volume of the base web of the filter medium and is common in the art to determine bulking thickness. The specific volume of the base web of the filter medium of the present invention may be reached by the use of curled fibers and uncurled fibers.

The term “curled fibers” as used herein refers to fibers having the shape of a helix or a spiral. The curled fibers differ from the uncurled fibers not only in shape, but also in the air permeability of media formed of curled fibers. The air permeability of media formed of curled fibers is typically at least 20% higher than the air permeability of media formed of corresponding uncurled fibers. Curled fibers are commercially available.

The term “non-impregnated” as used herein to describe the base web of cellulose fibers refers to the absence of a process of impregnating or saturating the base web with a liquid comprising a binder. The binder may include styrene-butadiene copolymer, polyvinyl alcohol, polyvinyl acetate, polyvinyl chloride, acrylates, polyurethanes and combinations thereof.

The term “tensile strength ratio MD/CD” as used herein refers to the characteristic of the strength of the base web in machine direction and cross direction. The value is calculated by dividing the tensile strength in machine direction by the tensile strength in cross direction. The tensile strength ratio ensures that the mechanical properties of the base web are sufficient to produce the filter of the present invention.

The term “laying on” as used herein refers to the process of laying a layer on top of another layer, i.e. a layer being disposed next to each other along a thickness direction of the base web.

The term “slurry” as used herein refers to a mixture comprising fibers and liquid.

The term “liquid” as used herein refers to any kind of solvent with which the fibers can form a slurry, the liquid is preferably water.

The term “substrate” as used herein may be a porous substrate, such as a wire mesh or porous screen of a paper machine, that allows liquid from the slurries to flow through, but not the fibers of the slurries. The liquid may be removed by vacuum, e.g. by reducing the pressure below the porous substrate, to effect a flow of liquid through the substrate.

The term “thickness direction” as used herein refers to the distance from one face of the base web to the other face of the base web and is typically the shortest distance from opposing faces of the base web.

In one aspect, a filter medium is provided comprising a base web of cellulose fibers, wherein the base web comprises a first and a second layer of cellulose fibers and a transition region between the first and the second layers, wherein the cellulose fibers of the first layer and the cellulose fibers of the second layer are intertwined in the transition region, wherein the first layer comprises more cellulose fibers, expressed as mass of cellulose fibers per unit area, than the second layer, and wherein the base web has a specific volume from 4 m³/g to 9 m³/g, preferably from 4.5 m³/g to 8 m³/g, more preferably from 5 m³/g to 7 m³/g and most preferably from 5.5 m³/g to 6.5 m³/g.

In embodiments, the base web of cellulose fibers included in the filter medium is a two-layered base web consisting of the first and the second layer of cellulose fibers with the transition region between them. Specifically, in this embodiment, the two-layered base web does not have a coating and it is a non-impregnated base web. This is because it was found that the impregnation (that can also be referred to as “saturation”) of the base web with a liquid comprising a binder and/or the presence of a coating might compromise the open structure of the base web. However, in this embodiment, the base web may optionally comprise a dry strength agent in an amount of up to 1.5 wt.-% and it may optionally comprise a sizing agent in an amount of up to 3.0 wt.-%, each in terms of the weight of the base web. One or more types of dry strength agents and one or more types of sizing agents may be used, with the total amount of dry strength agents and sizing agents, expressed in terms of the weight of the base web, being up to 1.5 wt.-% and up to 3.0 wt.-%, respectively. For instance, starch may be used as a dry strength agent and alkylene ketene dimers as a sizing agent. Owing to the use of cellulose fibers, which are biodegradable materials based on renewable resources, the filter medium is environmentally friendly.

In embodiments the air permeability of the base web included in the filter medium can be from 400 to 800 l/m²s, more preferably from 450 to 750 l/m²s, still more preferably from 500 to 700 l/m²s and most preferably from 550 to 650 l/m²s, wherein the air permeability is measured in accordance with ISO 9237:1995-12.

In embodiments, the thickness of the base web included in the filter medium can be from 150 μm to 300 μm, more preferably from 170 μm to 280 μm, still more preferably from 190 μm to 260 μm and most preferably from 210 μm to 240 μm, wherein the thickness is measured according to ISO 534:2012-02 at a pressure of the pressure plate of 0.1 bar.

In embodiments, the basis weight of the base web included in the filter medium can be from 25 g/m² to 55 g/m², more preferably from 30 g/m² to 50 g/m², still more preferably from 35 g/m² to 45 g/m² and most preferably from 35 g/m² to 40 g/m², wherein the basis weight is measured according to ISO 536:2019-11.

In embodiments, the maximum pore size in the base web can be 90 to 130 μm and preferably 100 to 120 μm according to DIN ISO 4003:1990-10. The pore size of many pores in the base web can be from 60 μm to 80 μm, preferably from 70 to 77 μm.

In embodiments, the tensile strength values in machine direction (MD) of the base web included in the filter medium can be from 10 N/15 mm to 40 N/15 mm, more preferably from 10 N/15 mm to 35 N/15 mm, still more preferably from 15 N/15 mm to 30 N/15 mm and most preferably from 15 N/15 mm to 25 N/15 mm. The tensile strength in MD is measured in accordance with ISO 1924-2:2009-05.

In embodiments, the tensile strength values in cross direction (CD) of the base web included in the filter medium can be from 1 N/15 mm to 20 N/15 mm, more preferably from 2 N/15 mm to 18 N/15 mm, still more preferably from 4 N/15 mm to 16 N/15 mm and most preferably from 6 N/15 mm to 14 N/15 mm. The tensile strength in CD is measured in accordance with ISO 1924-2:2009-05.

In embodiments, the tensile strength ratio MD/CD of the base web included in the filter medium can be from 2 to 3.2, more preferably from 2.1 to 2.8, still more preferably from 2.2 to 2.7. Both, the tensile strength in MD and CD are measured in accordance with ISO 1924-2:2009-05.

In embodiments, the elongation at break in MD of the base web included in the filter medium can be between from 1.4% to 2.5%, more preferably from 1.5% to 2.4% and still more preferably from 1.6% to 2.2% according to ISO 1924-2 2009-05.

In embodiments, the elongation at break in CD of the base web included in the filter medium can be from 3.0% to 5.5%, more preferably from 3.2% to 5.2%, still more preferably from 3.5% to 5.0% according to ISO 1924-2 2009-5.

In embodiments, the second layer of the base web included in the filter medium can contain curled fibers. The curled fibers are preferably curled softwood fibers, more preferably curled Northern bleached softwood kraft (NBSK) fibers and most preferably NBSK fibers from Europe. Also, the first layer of the base web can contain uncurled fibers.

In embodiments, the second layer of the base web included in the filter medium can contain 15 wt.-% to 40 wt.-%, more preferably 20 wt.-% to 35 wt.-% of curled fibers, in terms of the weight of the cellulose fibers of the second layer, which curled fibers are preferably curled softwood fibers, more preferably curled Northern bleached softwood kraft (NBSK) fibers and most preferably curled NBSK fibers from Europe.

In embodiments, the second layer of the base web included in the filter medium can comprise uncurled fibers, preferably in an amount of 60 wt.-% to 85 wt.-%, more preferably in an amount of at least 65 wt.-% to 80 wt.-%, in terms of the weight of the cellulose fibers of the second layer. As will be appreciated, the sum of the curled and the uncurled fibers in the base web, in terms of weight, is 100 wt.-%. According to a preferred embodiment, both, the curled and the uncurled fibers in the second layer of the base web, are softwood fibers, wherein the curled fibers are preferably NBSK fibers and more preferably NBSK fibers from Europe.

In embodiments, the base web included in the filter medium according to the present invention can contain 15 to 40 wt.-%, more preferably 20 to 35 wt.-% and still more preferably 25 to 35 wt.-% of curled fibers, in terms of the weight of the cellulose fibers of the base web in total.

In embodiments, the weight ratio of fibers of the first layer to the fibers of the second layer may be from 20:80 to 40:60, preferably from 25:75 to 35:65.

In embodiments, the cellulose fibers of the first layer may comprise softwood fibers and hardwood fibers.

In embodiments, the cellulose fibers of the second layer can be softwood fibers and are preferably Northern bleached softwood kraft (NBSK) fibers.

In embodiments, the base web included in the filter medium can be a non-impregnated base web of cellulose fibers.

In embodiments, the base web included in the filter medium can consist of cellulose fibers.

In embodiments, the filter medium may consist of the base web of cellulose fibers, which base web preferably consists of cellulose fibers.

In embodiments, the filter medium can be a cleanable filter medium, which is optionally cleanable by pressure shock pulsing.

When the filter medium is used for the filtration of fluids, such as liquids or air, preferably air, the first layer of cellulose fibers is preferably arranged upstream of the second layer of cellulose fibers.

When in use in a filter arrangement, filter element, air filter or pulse filter, the filter is preferably arranged upstream of further filters, such as the second filter of the filter arrangement as claimed, which second filter is preferably a glass filter, paper filter or meltblown filter. However, a pre-filter, such as a nonwoven pre-filter, can be present upstream of the filter medium, when the filter arrangement, filter element, air filter or pulse filter according to the claimed invention is in use for filtration. Moreover, another filter, preferably a nonwoven filter, can be present downstream of the filter medium in the filter element, air filter or pulse filter when they are used for filtration. When the filter arrangement in use, another filter which is preferably a nonwoven filter, can be present downstream of the second filter, which is preferably a glass filter, paper filter or meltblown filter.

In embodiments the filter medium comprising the base web of cellulose fibers, which can be a two-layered base web consisting of the first and the second layer of cellulose fibers with the transition region between them, has the following features in combination: the base web has a basis weight from 25 g/m² to 55 g/m², a thickness from 150 μm to 300 μm, a specific volume from 4 m³/g to 9 m³/g, an air permeability from 400 to 800 l/m²s, a maximum pore size from 90 μm to 130 μm and preferably a pore size of many pores from 60 μm to 80 μm.

In embodiments, the filter medium comprising the base web of cellulose fibers, which may be a two-layered base web consisting of the first and the second layer of cellulose fibers with the transition region between them, has the following features in combination: the base web has a basis weight from 30 g/m² to 50 g/m², a thickness from 170 μm to 280 μm, a specific volume from 5 m³/g to 7 m³/g, an air permeability from 450 to 750 l/m²s, a maximum pore size from 100 μm to 120 μm and preferably a pore size of many pores from 70 μm to 77 μm.

In embodiments, the filter medium comprising the base web of cellulose fibers, which may be a two-layered base web consisting of the first and the second layer of cellulose fibers with the transition region between them, has the following features in combination: the base web has a basis weight from 25 g/m² to 55 g/m², a thickness from 150 μm to 300 μm, a specific volume from 4 m³/g to 9 m³/g, an air permeability from 400 to 800 l/m²s, a maximum pore size from 90 μm to 130 μm, and preferably a pore size of many pores from 60 μm to 80 μm, the tensile strength ratio MD/CD of the base web is from 2 to 3.2, the elongation at break in MD of the base web is between from 1.4% to 2.5% and the elongation at break in CD from 3.0% to 5.5%.

In embodiments, the filter medium comprising the base web of cellulose fibers, which may be a two-layered base web consisting of the first and the second layer of cellulose fibers with the transition region between them, has the following features in combination: the base web has a basis weight from 30 g/m² to 50 g/m², a thickness from 170 μm to 280 μm, a specific volume from 5 m³/g to 7 m³/g, an air permeability from 450 to 750 l/m²s, a maximum pore size from 100 μm to 120 μm, and preferably a pore size of many pores from 70 μm to 77 μm, the tensile strength ratio MD/CD of the base web is from 2.1 to 2.8, the elongation at break in MD of the base web is from 1.5% to 2.4% and the elongation at break in CD is from 3.2% to 5.2%.

In embodiments, the filter medium comprising the base web of cellulose fibers, which may be a two-layered base web consisting of the first and the second layer of cellulose fibers with the transition region between them, has the following features in combination: the base web has a basis weight from 25 g/m² to 55 g/m², a thickness from 150 μm to 300 μm, a specific volume from 4 m³/g to 9 m³/g, an air permeability from 400 to 800 l/m²s, a maximum pore size from 90 μm to 130 μm, and preferably a pore size of many pores from 60 μm to 80 μm, the tensile strength ratio MD/CD of the base web is from 2 to 3.2, the elongation at break in MD of the base web is from 1.4% to 2.5%, the elongation at break in CD of the base web is from 3.0% to 5.5%, the second layer of the base web contains 15 wt.-% to 40 wt.-% of curled fibers in terms of the cellulose fibers of the second layer and uncurled fibers in an amount of 60 wt.-% to 85 wt.-% in terms of the weight of the cellulose fibers of the second layer, the weight ratio of fibers of the first layer to the fibers of the second layer is from 20:80 to 40:60, the cellulose fibers of the second layer are softwood fibers, the cellulose fibers of the first layer comprise softwood fibers and hardwood fibers, and the base web is a non-impregnated base web of cellulose fibers.

In embodiments, the filter medium comprising the base web of cellulose fibers, which may be a two-layered base web consisting of the first and the second layer of cellulose fibers with the transition region between them, has the following features in combination: the base web has a basis weight from 30 g/m² to 50 g/m², a thickness from 170 μm to 280 μm, a specific volume from 5 m³/g to 7 m³/g, an air permeability from 450 to 750 l/m²s, a maximum pore size from 100 μm to 120 μm, and preferably a pore size of many pores from 70 μm to 77 μm, the tensile strength ratio MD/CD of the base web is from 2.1 to 2.8, the elongation at break in MD of the base web is from 1.5% to 2.4%, the elongation at break in CD of the base web is from 3.2% to 5.2%, the second layer of the base web contains 20 wt.-% to 35 wt.-% of curled fibers in terms of the weight of the cellulose fibers of the second layer and uncurled fibers in an amount of 65 wt.-% to 80 wt.-% in terms of the weight of the cellulose fibers of the second layer, the weight ratio of fibers of the first layer to the fibers of the second layer is from 20:80 to 40:60, the cellulose fibers of the second layer are softwood fibers, the cellulose fibers of the first layer are softwood fibers and hardwood fibers, and the base web is a non-impregnated base web of cellulose fibers, preferably consisting of cellulose fibers.

According to another aspect, a filter arrangement is provided comprising an upstream and a downstream filter, wherein the upstream filter is a filter medium according to any of the above embodiments and wherein the downstream filter is optionally a glass filter, paper filter or meltblown filter.

According to still another aspect, a filter element is provided comprising a filter medium according to any of the above embodiments.

The base web included in the filter medium can be made by wet laying of fibers.

In embodiments, the process for producing a filter medium according to the present invention, comprises the following steps a) to d) to produce the base web, a) wet laying the first layer of cellulose fibers by disposing a first slurry containing a first liquid and cellulose fibers onto a substrate, b) while the first layer is still wet, wet laying the second layer by disposing a second slurry containing a second liquid and cellulose fibers onto the first layer to form the transition region, c) drying to remove the first and the second liquid thus forming the base web, and d) separating the base web from the substrate.

In embodiments, the first and the second slurries can be disposed using a paper machine, in particular the first and second slurries can be disposed on the wire of a paper machine, the wire acting as a substrate as mentioned above.

In embodiments, the first and the second liquid can be water.

In embodiments the second slurry can contain 15 wt.-% to 40 wt.-% of curled fibers in terms of the weight of the overall amount of fibers in the second slurry.

In embodiments the weight ratio of the cellulose fibers of the first layer to the cellulose fibers of the second layer may be from 20:80 to 40:60.

In one embodiment, the steps a) and b) may be performed before drying in step c), so that intertwining of the fibers in the first layer with the fibers in the second layer is allowed by wet laying the second layer on the first layer.

In one embodiment, a process for producing a filter medium according to the claimed invention, comprises the following steps a′), b′), c) and d) to produce the base web, a′) wet laying the second layer of cellulose fibers by disposing a second slurry containing a second liquid and cellulose fibers onto a substrate, b′) while the second layer is still wet, wet laying the first layer by disposing a first slurry containing a first liquid and cellulose fibers onto the second layer to form the transition region, c) drying to remove the first and the second liquid thus forming the base web, and d) separating the base web from the substrate.

The steps a′) and b′) may be performed before drying in step c), so that intertwining of the fibers of the first layer with the fibers in the second layer is allowed by wet laying the first layer on the second layer.

In embodiments the liquid of the slurry may be removed by drying at room temperature, or through heating, or by applying vacuum. In a preferred embodiment the liquid is removed by reducing the pressure below the porous substrate, preferably the wire of the paper machine, more preferably the inclined wire of the paper machine, most preferably the wire of the paper machine having an inclination angle in the range of 5° to 30° to effect a flow of liquid through the porous substrate, thus removing the liquid.

In embodiments the first and second slurries of the process according to the claimed invention may be wet laid using a paper making machine. The paper making machine preferably has a dual layer headbox, i.e. allowing two different slurries to be laid on top of one another.

In embodiments, the first slurry and second slurry as applied to the substrate may, respectively, contain the same or different types and proportions of fibers to form the base web. The concentrations of the different types of fibers within the first and second slurries and the relative volumes of first and second slurries applied to the substrate can be adjusted by the skilled person to reflect the desired relative amounts of fibers within the first and second layers. For example, the weight ratio of the fibers in the first layer to the fibers in the second layer is n:1, wherein n is >1. Accordingly, to achieve this with first and second slurries with the same total concentration of fibers as one another, a greater volume of the first slurry is laid down on a substrate (to form the first layer) in a wet laying technique, than the volume of the second slurry laid down on the first layer; similarly, where the first and second slurries have the same total concentration of fibers then the relative volumes of first and second slurries laid down on the substrate (or, in the case of the second slurry, on the first layer formed by the first slurry), i.e. volume of first slurry: volume of second slurry, may be n:1, e.g, wherein n is 2 to 10, optionally 3 to 5, optionally 3.5 to 4.5 optionally about 4. If the total concentration of fibers in first and second slurries is different, then the volume of the slurry laid down on the substrate can be adjusted accordingly by the skilled person, to ensure that the weight ratio of the fibers in the first layer to the fibers in the second layer is n:1, wherein n is >1.

In embodiments the first slurry and second slurry as applied to the substrate may, respectively, contain the same or different types and proportions of fibers to form the base web. The concentrations of the different types of fibers within the first and second slurries and the relative volumes of first and second slurries applied to the substrate can be adjusted by the skilled person to reflect the desired relative amounts of fibers within the first and second layers. For example, the weight ratio of the fibers in the first layer to the fibers in the second layer is n:1, wherein n is >1. Accordingly, to achieve this with first and second slurries with the same total concentration of fibers as one another, a smaller volume of the second slurry is laid down on a substrate (to form the second layer) in a wet laying technique, than the volume of the first slurry laid down on the second layer; similarly, where the first and second slurries have the same total concentration of fibers then the relative volumes of first and second slurries laid down on the substrate (or, in the case of the first slurry, on the second layer formed by the second slurry), i.e. volume of first slurry: volume of second slurry, may be n:1, e.g, wherein n is 2 to 10, optionally 3 to 5, optionally 3.5 to 4.5 optionally about 4. If the total concentration of fibers in first and second slurries is different, then the volume of the slurry laid down on the substrate can be adjusted accordingly by the skilled person, to ensure that the weight ratio of the fibers in the first layer to the fibers in the second layer is n:1, wherein n is >1.

The first layer and second layer may be lamellar, i.e. having first and second dimension that are larger in combination than a third dimension (i.e. a thickness direction), and typically overlap one another and occupy partly the same area of the base web. The fibers from the first layer are intertwined with the fibers from the second layer—this may be from forming first and second layer together, e.g. by wet laying both first and second layer together, as described herein, to allow intertwining of the fibers. Accordingly, at the point where the first and second layers meet, fibers from the first layer intertwine with the second layer and fibers from the second layer intertwine with fibers from the first layer, binding first and second layer together. This allows a continuum of the intertwined fibrous structure through the thickness of the base web and therefore a continuum of pores through the thickness of the base web. Thus, an abrupt interface as would be seen when two separately formed fibrous layers would be combined is avoided.

In embodiments, the slurries can be applied to the porous substrate in the wet-laying process, wherein the porous substrate is preferably the wire of a paper machine, which wire is more preferably inclined to the horizontal, still more preferably at an inclination angle in the range of 5° to 30° with respect to the horizontal. Suitable inclined wire paper machines are commercially available. The use of an inclined wire was found to contribute to generating a high specific volume of the base web such as in the range of 4 m³/g to 9 m³/g. This is explained by the inventors such that fibers will also orient themselves in z direction, i.e. in a thickness direction of the filter medium being manufactured, which is the case to a lesser degree when e.g. a rotoformer is used.

### Examples

### Example 1: Manufacturing of the Base Web of Cellulose Fibers as Filter Medium

The base web of cellulose fibers for the filter medium was produced as follows:

A slurry comprising softwood fibers and hardwood fibers with a weight ratio of 90:10 is introduced into first head-box of a wet-laying process. A slurry comprising only softwood fibers as fibers is introduced into a second headbox of a wetlaid process. A first layer is wet-laid on a porous substrate from the first-head box, then while the first layer is still wet, the second layer is wet-laid on the first layer from the second-head box. The ratio of the fibers of the first layer to the fibers of the second layer is 70:30 respectively. The liquid is removed from the first and second layer and they are dried to form a base web. The base web is then removed from the porous substrate to obtain the filter medium.

The features of the manufactured filter medium of cellulose fibers (referred to as Example 1 below) and of a conventional pulse filter medium (referred to as Comparative Example 1) as used in pulse filters are presented in Table 1. The pulse filter medium of Comparative Example 1 is made of a layer of impregnated paper and a nanofiber layer on the upstream side. L4-2iHPNFA1 standard material Neenah Gessner.

TABLE 1

| | Example 1 | Comparative Example 1 |
|---|---|---|
| Basis weight [g/m²] | 36 | 121 |
| Air permeability [l/m²*s] | 580 | 160 |
| Thickness [μm] (at 0.1 bar) | 220 | 410 |
| Tensile strength MD [N/15 mm] | 20 | / |
| Tensile strength CD [N/15 mm] | 9 | / |
| Elongation MD [%] | 1.7 | / |
| Elongation CD [%] | 4.0 | / |
| Burst strength [kPa] | 70 | >250 |
| Maximum pore size [μm] | 107 | <50 |
| Pore size of many pores [μm] | 74 | 38 |
| Specific volume [m³/g] | 6.1 | 3.4 |

From Table 1, it becomes apparent that the filter medium of Example 1 has a relatively low basis weight and thickness, whereas the air permeability, the specific volume and the pore size is significantly increased compared to the filter material of Comparative Example 1.

### Flat Sheet Testing:

The filter medium of Example 1 was further tested and compared to Comparative Example 1 in a flat sheet testing according to ISO 5011 The machine used was a Palas® MFP3000S, which is a machine for the measurement of the filter test bench. The separation efficiency of the filter medium of Example 1 and Comparative Example 1 was analysed. Therefore, the dust absorption and the air permeability was measured.

The test conditions according to ISO 5011 are described in Table 2.

TABLE 2

| Test conditions | |
|---|---|
| Face velocity [cm/s] | 4.2 |
| Final pressure drop [Pa] | 500 |
| Test dust | ISO fine (A2) |
| Dust concentration | 1000 |
| [mg/m³] | |
| Test area [cm²] | 100 |

The obtained data of the sheet testing according to ISO 5011 with the machine Palas® MFP 3000S is summarized in Table 3.

TABLE 3

| | | | | 500 Δp | | |
|---|---|---|---|---|---|---|
| | | | | increase | | |
| | air | | dp | pressure | dust | |
| | permeability | speed | start | increase | absorption | efficiency |
| material | [l/m²*s] | [cm/s] | [Pa] | [Pa] | [g/m²] | [%] |
| Exp. 1 | 506.5 | 4.2 | 13.9 | 507.9 | 96 | 99.16 |
| Comp. | 159.5 | 4.2 | 50.2 | 507.6 | 115.5 | 99.94 |
| Exp. 1 | | | | | | |

| | pressure normed | | | |
|---|---|---|---|---|
| | 500 Pa | | | |
| | dust | test | apparent | mass |
| | absorption | time | density | concentration |
| material | [g/m²] | [sec.] | [g/m³] | [mg/m³] |
| Exp. 1 | 94.5 | 2096 | 1150000 | 1100.1 |
| Comp. | 113.5 | 2527.5 | 1150000 | 1088.4 |
| Exp. 1 | | | | |

### Parameters of Table 3:

Speed: The speed describes the face velocity of the filter medium according to Table 2.

The initial pressure can be calculated by adding “dp start” to “pressure increase”.

Apparent density: The apparent density is the normed dust concentration in the air flow.

Mass concentration: The mass concentration is the dust concentration in the air.

From the data in Table 3, it becomes apparent that the filter medium of Example 1 has a highly increased air permeability. Thus, higher volumes of dust-laden air can be cleaned with efficiency similar to the filter medium of Comparative Example 1. The efficiency of the filter medium of Example 1 in relation to the dust particle size according to ISO 5011 is further shown in FIG. 2.

Pulse filter test: An additional test for the durability of the filter medium when applied as a cleanable surface filter (i.e. pulse filter) was conducted for the filter medium of Example 1 and Comparative Example 1. The filter test bench is conducted using a Topas test system (belonging to machine series AFC). A filter test was conducted for cleanable filters according to VDI 3926-2.

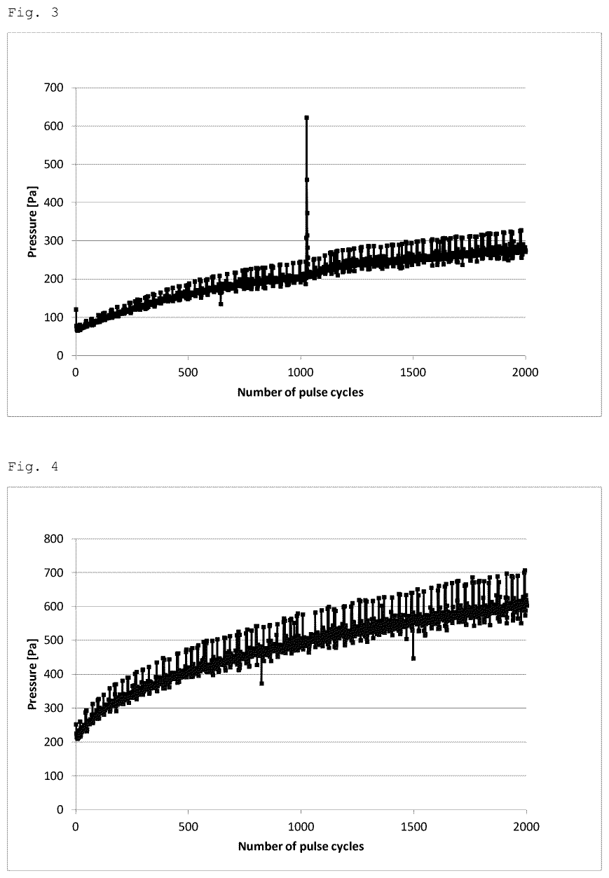

For the measurements of the deterioration of the filter medium after a certain number of pulse cycles with a standardized dust concentration of 5000 mg/m³, a test flow rate of 5 m³/h and a cycle frequency of 2000 pulse cycles à 5 s are performed to track the increase in counter pressure generated by the filter medium due to clogged pores. A pulse cycle of filter operation starts with particles being separated on the surface of the filter medium, which leads to a build-up of a dust cake. The dust cake then leads to an increased differential pressure. For regeneration a pressure shock from the up-flow side of the filter medium removes the filter cake and the pulse cycle starts again. The measurement to analyse the deterioration of the filter material comprising the filter medium of Example 1 or Comparative Example 1 is shown in FIG. 3 and FIG. 4, respectively. An increase in pulse cycle numbers leads to pressure increase for both materials, due to pore clogging.

However, it is remarkable that the filter medium produced in Example 1 and tested as a pulse filter already differs in a much lower initial pressure of around 70 Pa compared to the pulse filter of Comparative Example 1 with an initial pressure of about 215 Pa. After 2000 pulse cycles the pulse filter using the filter medium produced in Example 1 only shows an increase in pressure to about 270 Pa with a pressure difference (Δp) of Δp≈200 Pa. In contrast, the filter medium of Comparative Example 1 shows a pressure of around 600 Pa after the 2000th pulse cycle and a pressure difference of Δp≈375 Pa. As such the filter medium according to the claimed invention shows significant improvement in its deterioration performance and thus, a better overall lifetime which can be explained by less pore clogging.

### Test Methods

Before measuring any of the below parameters, the base web or filter medium according to the present invention will be conditioned at 23° C. and 50% humidity for at least 30 min. This is also mentioned in the ISO standards identified below.

Basis weight: The basis weight is determined according to the standard ISO 536:2019-11.

Air permeability: The air permeability is determined according to ISO 9237 1995-12.

Thickness: The thickness is determined according to the standard DIN EN ISO 534 2012-02.

Tensile strength: The tensile strength values in machine direction (MD) and the tensile strength values in cross direction (CD) are determined at 15 mm band width according to ISO 1924-2:2009-05.

Tensile strength ratio: The tensile strength ratio is determined by dividing tensile strength values measured in machine direction (MD) by tensile strength values measured in cross direction (CD)

Elongation at break: The elongation at break in machine direction (MD) and the elongation at break in cross direction (CD) are measured at 15 mm band width as per ISO 1924-2:2009-05.

Burst strength: The burst strength is determined according to DIN EN ISO 2758:2014-12.

Maximum pore size: The maximum pore size is determined according to ISO 4003:1990-10. The standard ISO 4003:1990-10 describes a gas bubble test for determining pore sizes of a test specimen. The pressure at which the first gas bubble becomes visible at the surface of the test specimen (e.g. the base web) is used to calculate based on the formula mentioned in section 4 of ISO 4003:1990-10 the maximum pore size of the test specimen. The test area of the test specimen can be 10 cm². Ethanol is preferably used as the test liquid in the measurement in accordance with ISO 4003:1990-10. Air is preferably used as the gas in the measurement in accordance with ISO 4003:1990-10.

Pore size of many pores: The “pore size of many pores” as used herein, is determined following ISO 4003:1990-10. That is, a measurement device described in section 5 of ISO 4003:1990-10 and schematically shown in the figure of ISO 4003:1990-10 is used and the measuring principle and measuring procedure described in ISO 4003:1990-10 are employed. The pressure at which gas bubbles form throughout the entire surface of the test specimen without foam formation is used to calculate the “pore size of many pores” based on the formula mentioned in section 4 of ISO 4003:1990-10. The test area of the test specimen can be 10 cm². Ethanol is preferably used as the test liquid in the measurement following ISO 4003:1990-10. Air is preferably used as the gas in the measurement following ISO 4003:1990-10.

Specific volume: The specific volume (Vsp) is obtained by the following formula: Vsp [m³/g]=(thickness [mm]×1000)/basis weight [g/m²]. The thickness and the basis weight are determined as described above.

While the devices, systems, and methods have been described in detail herein in accordance with certain preferred embodiments thereof, many modifications and changes therein may be affected by those skilled in the art. Accordingly, the foregoing description should not be construed to be limited thereby but should be construed to include such aforementioned obvious variations and be limited only by the spirit and scope of the following claims.

For example, in a first aspect a first embodiment is a filter medium comprising a base web of cellulose fibers, wherein the base web comprises a first and a second layer of cellulose fibers and a transition region between the first and the second layers, wherein the cellulose fibers of the first layer and the cellulose fibers of the second layer are intertwined in the transition region, wherein the first layer comprises more cellulose fibers, expressed as mass of cellulose fibers per unit area, than the second layer, and wherein the base web has a specific volume from 4 m³/g to 9 m³/g, preferably from 4.5 m³/g to 8 m³/g, more preferably from 5 m³/g to 7 m³/g and most preferably from 5.5 m³/g to 6.5 m³/g.

A second embodiment is the first embodiment, wherein the base web of cellulose fibers is a two-layered base web consisting of the first and the second layer of cellulose fibers with the transition region between them.

A third embodiment is any combination of the above embodiments, wherein the air permeability of the base web is from 400 to 800 l/m²s.

A 4th embodiment is any combination of the above embodiments, wherein the thickness of the base web is from 150 μm to 300 μm at 0.1 bar.

A 5th embodiment is any combination of the above embodiments, wherein the basis weight of the base web is from 25 to 55 g/m².

A 6th embodiment is any combination of the above embodiments, wherein the tensile strength ratio MD/CD of the base web is from 2 to 3.2.

A 7th embodiment is any combination of the above embodiments, wherein the second layer contains curled fibers.

An 8th embodiment is any combination of the above embodiments, wherein the second layer contains 15 wt.-% to 40 wt.-% of curled fibers, in terms of the weight of the cellulose fibers of the second layer.

A 9th embodiment is any combination of the above embodiments, wherein the second layer comprises uncurled fibers, preferably in an amount of 60 to 85 wt.-%, in terms of weight of the cellulose fibers of the second layer.

A 10th embodiment is any combination of the above embodiments, wherein the base web contains 15 to 40 wt.-%, preferably 25 to 35 wt.-%, of curled fibers, in terms of the weight of the cellulose fibers of the base web in total.

An 11th embodiment is any combination of the above embodiments, wherein the cellulose fibers of the second layer are softwood fibers.

A 12th embodiment is any combination of the above embodiments, wherein the base web is a non-impregnated base web of cellulose fibers and/or wherein the base web does not have a coating.

A 13th embodiment is any combination of the above embodiments, wherein the base web consists of cellulose fibers and optionally a dry strength agent in an amount of up to 1.5 wt.-% and optionally a sizing agent in an amount of up to 3.0 wt.-%, each in terms of the weight of the base web.

A 14th embodiment is any combination of the above embodiments, which consists of the base web of cellulose fibers.

A 15th embodiment is any combination of the above embodiments, which is a cleanable filter medium, which is optionally cleanable by pressure shock pulsing.

A 16th embodiment is any combination of the above embodiments, wherein the first filter is a filter medium according to any one of items (1) to (15) and wherein the second filter is optionally a glass filter, paper filter or meltblown filter.

A 17th embodiment is any combination of the above embodiments, wherein the first filter is arranged upstream of the second filter when the filter arrangement is in use.

An 18th embodiment is any combination of the above embodiments, which further comprises one or two nonwoven filter layers that are optionally arranged upstream of the first and/or downstream of the second filter when the filter arrangement is in use.

A 19th embodiment is a filter element comprising the filter medium of any combination of the above embodiments.

A 20th embodiment is an air filter comprising the filter medium of any combination of the above embodiments.

A 21^{st} embodiment is a pulse filter comprising the filter medium of any combination of the above embodiments.

In another aspect, a first embodiment is a process for producing a filter medium according to any one of items (1) to (15), comprising the following steps a) to d) to produce the base web, a) wet laying the first layer of cellulose fibers by disposing a first slurry containing a first liquid and cellulose fibers onto a substrate, which is preferably a porous substrate b) while the first layer is still wet, wet laying the second layer by disposing a second slurry containing a second liquid and cellulose fibers onto the first layer to form the transition region, c) drying to remove the first and the second liquid thus forming the base web, and d) separating the base web from the substrate.

In another aspect, a first embodiment is a process for producing a filter medium according to any one of items (1) to (15), comprising the following steps a′), b′), c) and d) to produce the base web,
a′) wet laying the second layer of cellulose fibers by disposing a second slurry containing a second liquid and cellulose fibers onto a substrate, which is preferably a porous substrate,
b′) while the second layer is still wet, wet laying the first layer by disposing a first slurry containing a first liquid and cellulose fibers onto the second layer to form the transition region, c) drying to remove the first and the second liquid thus forming the base web, and
d) separating the base web from the substrate.

A second embodiment is any combination of the above embodiments, wherein the first and the second slurries are disposed on the wire of a paper machine as a substrate.

A third embodiment is any combination of the above embodiments, wherein the wire of the paper machine is inclined.

A 4th embodiment is any combination of the above embodiments, wherein the wire of the paper machine is inclined at an angle in the range of 5° to 30° with respect to the horizontal.

A 5th embodiment is any combination of the above embodiments, wherein the first and the second liquid is water.

A 6th embodiment is any combination of the above embodiments, wherein the second slurry contains 15 to 40 wt.-%, preferably 25 to 35 wt.-%, of curled fibers in terms of the overall weight of fibers in the second slurry.

A 7th embodiment is any combination of the above embodiments, wherein the weight ratio of the cellulose fibers of the first layer to the cellulose fibers of the second layer is from 20:80 to 40:60.

In another aspect, a filter medium is provided in any combination of the above embodiments, wherein the base web has a maximum pore size of 90 μm to 130 μm and preferably of 100 μm to 120 μm.

What is claimed is:

1. A filter medium comprising
a base web of cellulose fibers, wherein the base web comprises a first layer of cellulose fibers and a second layer of cellulose fibers and a transition region between the first and the second layers,
wherein the cellulose fibers of the first layer and the cellulose fibers of the second layer are intertwined in the transition region, wherein the base web has a specific volume from about 4 m³/g to about 9 m³/g.

2. The filter medium of claim 1, wherein the first layer comprises more cellulose fibers, expressed as mass of cellulose fibers per unit area, than the second layer.

3. The filter medium of claim 1, wherein the base web of cellulose fibers is a two-layered base web consisting of the first and the second layer of cellulose fibers with the transition region between them.

4. The filter medium of claim 1, wherein the base web comprises an air permeability from about 400 to about 800 l/m²s.

5. The filter medium of claim 1, wherein the base web has a thickness thereof from about 150 μm to about 300 μm.

6. The filter medium of claim 1, wherein the base web has a basis weight from about 25 to about 55 g/m².

7. The filter medium of claim 1, wherein the base web has a tensile strength ratio MD/CD thereof is from about 2 to about 3.2.

8. The filter medium of claim 1, wherein the base web has a maximum pore size from about 90 μm to about 130 μm.

9. The filter medium of claim 1, wherein the second layer contains curled fibers, in an amount of 15 wt.-% to 40 wt.-%, in terms of the weight of the cellulose fibers of the second layer.

10. The filter medium of claim 1, wherein the second layer comprises uncurled fibers, in an amount of 60 to 85 wt.-%, in terms of weight of the cellulose fibers of the second layer.

11. The filter medium of claim 1, wherein the base web contains about 15 to 40 wt.-% of curled fibers, in terms of the weight of the cellulose fibers of the base web in total.

12. The filter medium of claim 1, wherein the cellulose fibers of the second layer are softwood fibers.

13. The filter medium of claim 1, wherein the base web is a non-impregnated base web of cellulose fibers.

14. A filter comprising the filter medium of claim 1.

15. The filter of claim 14, wherein the filter is a pulse filter.

16. A filter arrangement comprising:
a first filter a base web of cellulose fibers, wherein the base web comprises a first layer of cellulose fibers and a second layer of cellulose fibers and a transition region between the first and the second layers, wherein the cellulose fibers of the first layer and the cellulose fibers of the second layer are intertwined in the transition region, wherein the base web has a specific volume from about 4 m³/g to about 9 m³/g and;
a second filter.

17. The filter arrangement of claim 16, wherein the second filter comprises a glass filter.

18. The filter arrangement of claim 16, wherein the second filter comprises a paper filter.

19. The filter arrangement of claim 16, wherein the second filter comprises a meltblown filter.

20. The filter arrangement of claim 15, further comprising at least one nonwoven filter layer arranged upstream of the first filter or downstream of the second filter.
